(19) United States
(12) Patent Application Publication
(10) Pub. No.: US 2015/0063869 A1
(43) Pub. Date: Mar. 5, 2015

(54) IMAGE FORMING APPARATUS

(71) Applicant: Samsung Electronics Co., Ltd., Suwon-si (KR)

(72) Inventors: Hyun Ki CHO, Yongin-si (KR); Young Jae PARK, Suwon-si (KR)

(73) Assignee: Samsung Electronics Co., Ltd., Suwon-si (KR)

(21) Appl. No.: 14/310,622

(22) Filed: Jun. 20, 2014

(30) Foreign Application Priority Data
Aug. 30, 2013 (KR) 10-2013-0103950

(51) Int. Cl. G03G 15/00

(52) U.S. Cl. CPC G03G 15/757
USPC 399/167

(57) ABSTRACT

An image forming apparatus is provided. The image forming apparatus may mechanically synchronize eccentricity and run-out deviation for each photosensitive drum of an image forming apparatus that does not individually drive the photosensitive drums. The image forming apparatus includes photosensitive drums in which electrostatic latent images are formed, a single motor configured to rotate the photosensitive drums, driving gears configured to transmit a rotating force of the single motor to the plurality of photosensitive drums, and couplers interposed between the photosensitive drums and the driving gears and configured to enable the photosensitive drums and the driving gears to be synchronized with each other in such a manner that any one of the photosensitive drums and the driving gears follows a phase of the other one thereof when the photosensitive drums are coupled to the driving gears.

### CROSS-REFERENCE TO RELATED APPLICATIONS

This application is related to, and claims the priority benefit of, Korean Patent Application No. 10-2013-0103950, filed on Aug. 30, 2013 in the Korean Intellectual Property Office, the disclosure of which is incorporated herein by reference.

### BACKGROUND

1. Field

Embodiments relate to an image forming apparatus and more particularly to an image forming apparatus that may form color images using a plurality of photosensitive drums.

2. Description of the Related Art

In general, an image forming apparatus refers to an apparatus that forms electrostatic latent images, which are electrified with a prescribed potential, by scanning a photosensitive drum with light, develops the electrostatic latent images with a single color or multiple color toner, and then transfers and fixes the developed toner images on a paper to form color images.

The image forming apparatus for color images includes a toner having a plurality of color toners such as cyan, magenta, yellow, and black that are called CMYK, and the like. Through combination between the respective color toners, the colors of print data may be implemented. The plurality of color toners may be printed on one surface a plurality of times when printing of a color document is performed, unlike usual printing of a black-and-white document. While printing the plurality of color toners on one surface, a problem may arise such that each color cannot be exactly printed at a desired position due to several causes. This may be referred to as color mis-registration.

Many photosensitive drums (OPC drum) have a periodic speed variation. This phenomenon occurs in most rotor systems unless the system is an ideally complete rotor system. The periodic speed variation of the photosensitive drum have several fundamental causes such as a shape error (eccentricity or run-out), alignment, and mountability of the photosensitive drum, a shape error of gears of a driving system, a transmission error of gears, structural imperfection of gears, a coupling angular velocity transfer error, and the like. The speed variation of the photosensitive drum that occurs due to these causes may be a direct cause of the color mis-registration. In order to maintain the constant-speed property of the photosensitive drum that has a relationship, e.g., direct relationship with such a color mis-registration phenomenon, efforts to improve individual control technology such as individually driving each of the plurality of photosensitive drums using a plurality of motors in order to cancel a difference in the speed variation for each of the plurality of photosensitive drums as well as efforts to minimize a mechanical deviation such as structural stability of a driving unit and a developing unit, a gear/coupling degree, tolerance management, and the like are desired.

### SUMMARY

It is an aspect to provide an image forming apparatus that may mechanically synchronize eccentricity and run-out deviation for each photosensitive drum of an image forming apparatus which does not individually drive the photosensitive drums.

Additional aspects are set forth in part in the description that follows and, in part, will be obvious from the description, or may be learned by practice of the invention.

In accordance with an aspect of an embodiment, an image forming apparatus includes a plurality of photosensitive drums, a single motor, a plurality of driving gears installed in accordance with a predetermined phase so as to cancel deviation therebetween and simultaneously driven by the single motor, a plurality of driving side couplers provided in each of the plurality of driving gears and rotated together with the plurality of driving gears, and a plurality of driven side couplers provided in each of the plurality of photosensitive drums and coupled to the plurality of driving side couplers, wherein, when at least one of the plurality of photosensitive drums is coupled to at least one of the plurality of driving gears, the driving side coupler and the driven side coupler are coupled to each other in an one-direction coupling method, and therefore the plurality of photosensitive drums follow the predetermined phase of the plurality of driving gears.

A single fastening groove having directivity may be formed in the plurality of driven side couplers, a single protrusion having directivity may be formed in the plurality of driving side couplers, and the protrusion of the plurality of driving side couplers may be inserted into the fastening groove of the plurality of driven side couplers in accordance with the directivity when the plurality of photosensitive drums are coupled to the plurality of driving gears.

The fastening groove of the plurality of driven side couplers may be asymmetrically formed so as to have the directivity.

An elastic body may be provided in each of the plurality of driving side couplers, and when at least one of the plurality of photosensitive drums is coupled to at least one of the plurality of driving gears, the plurality of driving side couplers may be pressurized toward the plurality of driven side couplers by the elastic body so that a bonding force between the plurality of driving side couplers and the plurality of driven side couplers is maintained.

At least two fastening grooves having mutually different directivity may be formed in the plurality of driven side couplers, at least two protrusions having mutually different directivity may be formed in the plurality of driving side couplers, and when the plurality of photosensitive drums are coupled to the plurality of driving gears, the at least two protrusions of the plurality of driving side couplers may be inserted into the fastening groove having corresponding directivity of the plurality of driven side couplers so that the plurality of photosensitive drums and the plurality of driving gears are coupled to each other in the one-direction coupling method.

The at least two fastening grooves of the plurality of driven side couplers may be formed into mutually different shapes so as to have the directivity.

The at least two fastening grooves of the plurality of driven side couplers may be formed to have mutually different sizes so as to have the directivity.

An elastic body may be provided in each of the plurality of driving side couplers, and when at least one of the plurality of photosensitive drums is coupled to at least one of the plurality of driving gears, the plurality of driving side couplers may be pressurized toward the plurality of driven side couplers by the elastic body so that a bonding force between the plurality of driving side couplers and the plurality of driven side couplers is maintained.

An insertion port in which a rotating shaft of the driving gear is inserted and fixed may be formed in a center portion of each of the plurality of driving side couplers, and the elastic body may be installed at an inlet side of the insertion port.

A groove position detecting protrusion may be formed in at least one of the plurality of driving gears, and the image forming apparatus may further include a single groove position sensing unit for detecting the groove position detecting protrusion.

The groove position detecting protrusion may be formed on a surface of at least one of the plurality of driving gears so as to have a semicircular arc shape.

The groove position sensing unit may include a light emitting unit and a light receiving unit, and a groove position of the photosensitive drum may be determined through a difference between a light receiving state when the groove position detecting protrusion is positioned between the light emitting unit and the light receiving unit of the groove position sensing unit and a light receiving state when the groove position detecting protrusion is deviated from between the light emitting unit and the light receiving unit.

In accordance with an aspect of an embodiment, an image forming apparatus includes a plurality of photosensitive drums, a single motor; a plurality of driving gears installed in accordance with a predetermined phase so as to cancel deviation therebetween and simultaneously driven by the single motor, a plurality of driving side couplers provided in each of the plurality of driving gears and rotated together with the plurality of driving gears, and a plurality of driven side couplers provided in each of the plurality of photosensitive drums and coupled to the plurality of driving side couplers, wherein a single fastening groove having directivity is formed in the plurality of driven side couplers, a single protrusion having directivity is formed in the plurality of driving side couplers, and when at least one of the plurality of photosensitive drums is coupled to at least one of the plurality of driving gears, the driving side coupler and the driven side coupler are coupled in an one-directional coupling method by the directivity of the single protrusion and the directivity of the single groove, and therefore the plurality of photosensitive drums follow the predetermined phase of the plurality of driving gears.

In accordance with an aspect of an embodiment, an image forming apparatus includes a plurality of photosensitive drums, a single motor, a plurality of driving gears installed in accordance with a predetermined phase so as to cancel deviation therebetween and simultaneously driven by the single motor, a plurality of driving side couplers provided in each of the plurality of driving gears and rotated together with the plurality of driving gears, and a plurality of driven side couplers provided in each of the plurality of photosensitive drums and coupled to the plurality of driving side couplers, wherein at least two fastening grooves having mutually different directivity are formed in the plurality of driven side couplers, at least two protrusions having mutually different directivity are formed in the plurality of driving side couplers, and when at least one of the plurality of photosensitive drums is coupled to at least one of the plurality of driving gears, the driving side coupler is coupled to the driven side coupler in an one-directional coupling method by the directivity of the at least two protrusions and the directivity of the at least two grooves, and therefore the plurality of photosensitive drums follow the predetermined phase of the plurality of driving gears.

### BRIEF DESCRIPTION OF THE DRAWINGS

These and/or other aspects will become apparent and more readily appreciated from the following description of the embodiments, taken in conjunction with the accompanying drawings of which:

FIG. 1 illustrates a configuration of an image forming apparatus in accordance with an embodiment;

FIG. 2 illustrates a control system of an image forming apparatus in accordance with an embodiment;

FIGS. 3A and 3B illustrate characteristics of a photosensitive drum having eccentricity and run-out;

FIG. 4 is an exploded perspective view illustrating a connection relationship between a photosensitive drum and a motor of an image forming apparatus in accordance with an embodiment;

FIG. 5 illustrates an exemplary connection relationship between the photosensitive drum and the motor of the image forming apparatus illustrated in FIG. 4;

FIGS. 6A to 6D illustrate an exemplary embodiment of a coupler that connects a driving gear and a photosensitive drum of an image forming apparatus in accordance with one embodiment;

FIGS. 7A to 7D illustrate an exemplary embodiment of a coupler that connects a driving gear and a photosensitive drum of an image forming apparatus in accordance with one embodiment;

FIGS. 8A and 8B illustrate a groove position detecting protrusion and a groove position sensing unit that are provided in a driving gear of an image forming apparatus in accordance with an embodiment;

FIG. 9 illustrates phase synchronization of a driving gear of an image forming apparatus in accordance with an embodiment;

FIGS. 10A and 10B illustrates a detection result of AC components of a photosensitive drum of an image forming apparatus in accordance with an embodiment;

FIG. 11 illustrates a test pattern for performing automatic color registration (ACR) of a photosensitive drum in an image forming apparatus in accordance with one embodiment; and

FIG. 12 illustrates results of phase synchronization control and AC average control of an image forming apparatus in accordance with one embodiment.

### DETAILED DESCRIPTION

Reference will now be made in detail to the embodiments, examples of which are illustrated in the accompanying drawings, wherein like reference numerals refer to like elements throughout.

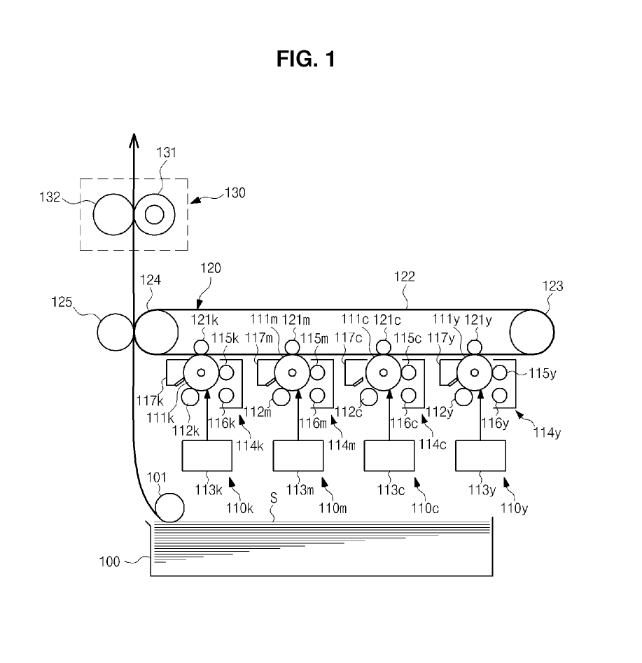

FIG. 1 illustrates a configuration of an image forming apparatus in accordance with an embodiment.

As illustrated in FIG. 1, the image forming apparatus in accordance with an embodiment includes a paper feed unit 100, image forming units 110k, 110m, 110c, and 110y, a transfer unit 120, and a fixing unit 130. The paper feed unit 100 feeds a recording medium (S) such as a paper, and the recording medium (S) loaded in a paper feed cassette may be picked up by a pick-up roller 112 to be conveyed. The image forming units 110k, 110m, 110c, and 110y may be disposed above the paper feed unit 100, and form developer images with predetermined colors such as black (K), magenta (M), cyan (Y), and yellow (Y) on the recording medium (S).

The image forming units 110k, 110m, 110c, and 110y include, for example, four photosensitive drums 111k, 111m, 111c, and 111y. The photosensitive drums 111k, 111m, 111c, and 111y may be disposed in parallel with each other at prescribed intervals so as to face an intermediate transfer belt 122 of the transfer unit 120. The photosensitive drums 111k, 111m, 111c, and 111y may contact the intermediate transfer belt 122 at a constant pressure by four transfer rollers 121k, 121m, 121c, and 121y of the transfer unit 120 to thereby form a nip, and may be rotated counterclockwise by a gear member to which power is transmitted from a motor. Four electrifying units 112k, 112m, 112c, and 112y, four laser scanning units 113k, 113m, 113c, and 113y, and four developing units 114k, 114m, 114c, and 114y may be disposed around the photosensitive drums 111k, 111m, 111c, and 111y.

Each of the electrifying units 112k, 112m, 112c, and 112y includes an electrifying roller. The electrifying units 112k, 112m, 112c, and 112y respectively contact surfaces of the photosensitive drums 111k, 111m, 111c, and 111y. The first, second, third, and fourth electrifying units 112k, 112m, 112c, and 112y may be applied with a prescribed electrification bias voltage, and form a prescribed electrification potential on the surface of the photosensitive drums 111k, 111m, 111c, and 111y, for example, form an electrification potential of about 600 V when a developer has a negative (−) polarity.

The laser scanning units 113k, 113m, 113c, and 113y irradiate the surface of the photosensitive drums 111k, 111m, 111c, and 111y electrified by the electrifying units 112k, 112m, 112c, and 112y with a laser beam so that a model corresponding to image signals input from a computer, a scanner, or the like is formed, thereby forming electrostatic latent images having a prescribed potential lower than the electrification potential, for example, a low potential area of about −50 V.

The developing units 114k, 114m, 114c, and 114y apply a developer with a color corresponding to the image signal to the surface of the photosensitive drums 111k, 111m, 111c, and 111y in which the electrostatic latent images are formed, thereby developing the electrostatic latent images into visible developer images. The developing units 114k, 114m, 114c, and 114y include four developing rollers 115k, 115m, 115c, and 115y, and four developer feed rollers 116k, 116m, 116c, and 116y.

The developing rollers 115k, 115m, 115c, and 115y are rotated while being engaged with the photosensitive drums 111k, 111m, 111c, and 111y, and apply the developer to the electrostatic latent images of the photosensitive drums 111k, 111m, 111c, and 111y, thereby developing the electrostatic latent images into visible developer images. The developing rollers 115k, 115m, 115c, and 115y may be disposed adjacent to the surface of the photosensitive drums 111k, 111m, 111c, and 111y, and may be rotated clockwise by a power transmission gear connected to the gear member that drives the photosensitive drums 111k, 111m, 111c, and 111y. A prescribed developing bias voltage lower by 100 to 400 V than that of the developer feed rollers 116k, 116m, 116c, and 116y, for example, a voltage of −250 V may be applied to the developing rollers 115k, 115m, 115c, and 115y.

The developer feed rollers 116k, 116m, 116c, and 116y feed the developer to the developing rollers 115k, 115m, 115c, and 115y using a potential difference with the developing rollers 115k, 115m, 115c, and 115y. The developer feed rollers 116k, 116m, 116c, and 116y may be disposed so as to contact a lower portion of one side surface of the developing rollers 115k, 115m, 115c, and 115y, thereby forming a nip. The developer of black (K), magenta (M), cyan (C), and yellow (Y) may be conveyed to a lower space between the developer feed rollers 116k, 116m, 116c, and 116y and the developing rollers 115k, 115m, 115c, and 115y.

A prescribed developer feed bias voltage higher by 100 to 400 V than that of the developing rollers 115k, 115m, 115c, and 115y, for example, a voltage of −500 V may be applied to the developer feed rollers 116k, 116m, 116c, and 116y. Thus, the developer which has been conveyed to the lower space between the developer feed rollers 116k, 116m, 116c, and 116y and the developing rollers 115k, 115m, 115c, and 115y has a charge due to a charge injected by the developer feed rollers 116k, 116m, 116c, and 116y, may be applied to the developing rollers 115k, 115m, 115c, and 115y having a relatively low potential, and conveyed to the nip between the developer feed rollers 116k, 116m, 116c, and 116y and the developing rollers 115k, 115m, 115c, and 115y.

Four cleaning units 117k, 117m, 117c, and 117y clean waste developer remaining on the surface of the photosensitive drums 111k, 111m, 111c, and 111y after rotation, e.g, one-cycle rotation of the photosensitive drums 111k, 111m, 111c, and 111y.

The transfer unit 120 includes transfer rollers 121k, 121m, 121c, and 121y, an intermediate transfer belt 122, and a final transfer roller 125. The developer images formed in the photosensitive drums 111k, 111m, 111c, and 111y may be transferred to the intermediate transfer belt 122 by the transfer rollers 121k, 121m, 121c, and 121k, and the images transferred to the intermediate transfer belt 122 are transferred to the recording medium (S) that is fed from the paper feed unit 100 and passes between the final transfer roller 125 and the intermediate transfer belt 122.

The intermediate transfer belt 122 may be provided so as to be wound around a support roller 124 that contacts driving rollers 123 disposed so as to be laterally spaced apart from each other and an inner surface of the intermediate transfer belt 122, and provided so as to travel from the first developing unit 114k toward the fourth developing unit 114y.

The transfer rollers 121k, 121m, 121c, and 121y are transfer voltage applying members that apply a prescribed transfer bias voltage to the intermediate transfer belt 122, and may be disposed so as to respectively pressurize the intermediate transfer belt 122 against the photosensitive drums 111k, 111m, 111c, and 111y on an inner side of the intermediate transfer belt 122 at a constant pressure. A prescribed transfer bias voltage may be applied to the transfer rollers 121k, 121m, 121c, and 121y.

The final transfer roller 125 may be installed so as to face the intermediate transfer belt 122. The final transfer roller 125 may be spaced apart from the intermediate transfer belt 122 while the developer image is transferred to the intermediate transfer belt 122, and may be brought into contact with the intermediate transfer belt 122 at a prescribed pressure when the developer image is completely transferred to the intermediate transfer belt 122. A prescribed transfer bias voltage may be applied to the final transfer roller 125 so as to transfer the developer image transferred to the intermediate transfer belt 122 to the recording medium (S).

The fixing unit 130 fixes the developer image transferred to the recording medium (S), and includes a heating roller 131 and a pressure roller 132. The heating roller 131 includes a heater provided therein so as to fix the developer image to the recording medium (S) by a high-temperature heat.

The pressure roller 132 is installed to be pressurized against the heating roller 131 by an elastic pressing member so as to pressurize the recording medium (S). The number of respective units, drums, etc. illustrated in FIG. 1 is exemplary and may be a number different than four.

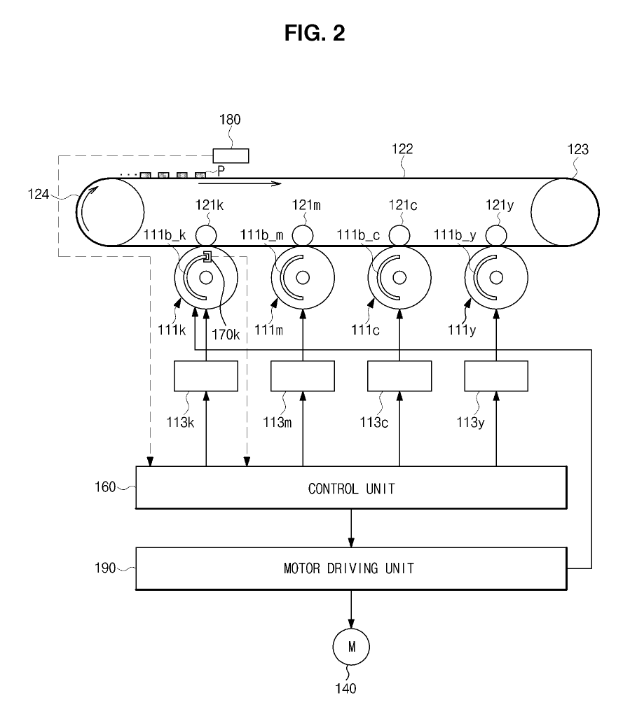

FIG. 2 is a schematic diagram illustrating a control system of an image forming apparatus in accordance with an embodiment.

As illustrated in FIG. 2, the image forming apparatus in accordance with an embodiment includes a control unit 160 that performs control, e.g, overall control, a groove position sensing unit (for example, 170k), e.g, a single groove position sensing unit that detects a groove position of a photosensitive drum (for example, 111k) e.g., a single photosensitive drum, a pattern detecting unit e.g., single pattern detecting unit 180 that detects a color mis-registration detecting pattern P transferred to the intermediate transfer belt 122 by each of the photosensitive drums 111k, 111m, 111c, and 111y, and a motor driving unit 190 that drives a motor, e.g, a single motor 140 corresponding to the four photosensitive drums 111k, 111m, 111c, and 111y.

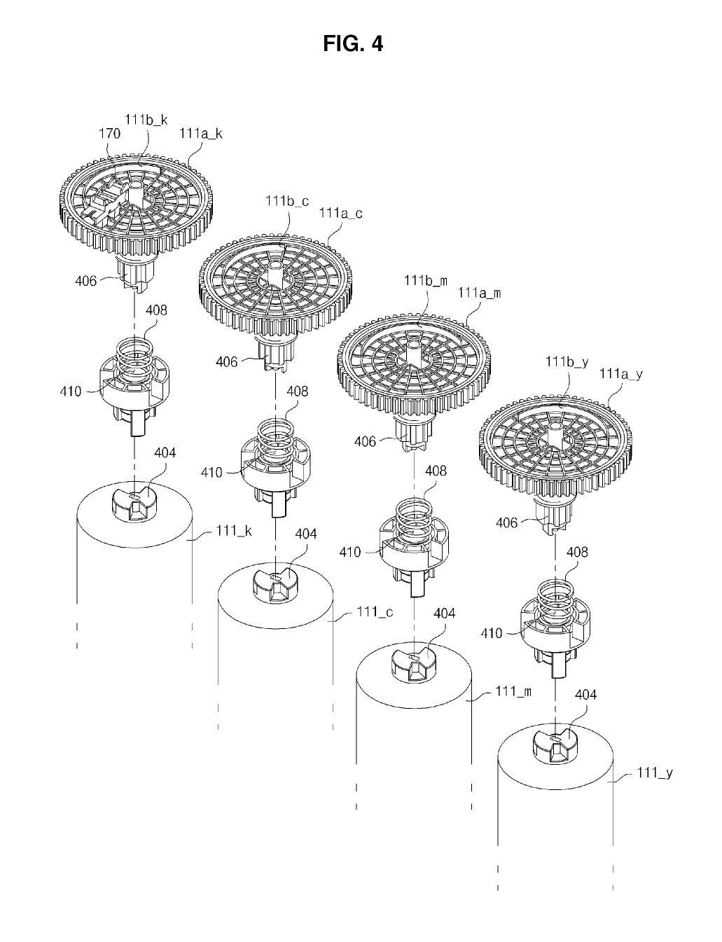

The groove position sensing units 170k, 170m, 170c, and 170y include optical sensors, and detect a position of a groove position detecting protrusion 111b_{—}k formed on a side, e.g., one side of the driving gear 111a connected to the drum, e.g., single photosensitive drum 111k that is a reference, thereby detecting a groove position of the single photosensitive drum 111k that is the reference. Groove position detecting protrusions 111b_{—}c, 111b_{—}m, and 111b_{—}y are illustrated in FIG. 4.

The pattern detecting unit 180 includes a color toner density (CTD) sensor. The pattern detecting unit 180 irradiates the color mis-registration detecting pattern P, which is transferred to the intermediate transfer belt 122 for each of the photosensitive drums 111k, 111m, 111c, and 111y, with, for example, infrared rays, and detects intensity of reflected light reflected from the color mis-registration detecting pattern P or a non-pattern area.

The control unit 160 forms the color mis-registration detecting pattern P in corresponding photosensitive drums 111k, 111m, 111c, and 111y through the corresponding laser scanning units 113k, 113m, 113c, and 113y for each of the photosensitive drums 111k, 111m, 111c, and 111y, and transfers the color mis-registration detecting pattern P formed in the corresponding photosensitive drums 111k, 111m, 111c, and 111y to the intermediate transfer belt 122.

The control unit 160 detects the color mis-registration detecting pattern P transferred to the intermediate transfer belt 122 for each of the photosensitive drums 111k, 111m, 111c, and 111y, and performs auto color registration in order to improve the color mis-registration of the photosensitive drum 111. The number of respective units, drums, etc. illustrated in FIG. 2 is exemplary and may be a number different than four

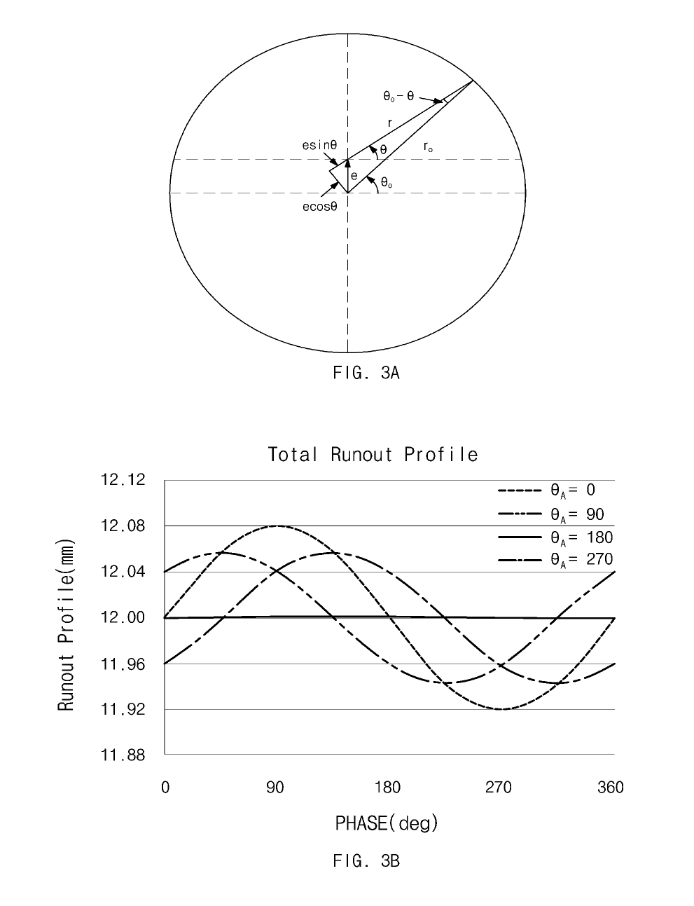

FIGS. 3A and 3B illustrate exemplary characteristics of a photosensitive drum having eccentricity and run-out. In FIG. 3A, a radius of a cross-section of the photosensitive drum 111 when the photosensitive drum 111 that is a rotor has eccentricity and run-out characteristics is illustrated. In FIG. 3B, an exemplary alternate current (AC) component of the photosensitive drum 111 having eccentricity and run-out characteristics is illustrated.

As illustrated in FIG. 3A, a radius (r) of a general rotor has the following geometric variation characteristics through a geometric relationship illustrated in FIG. 3A.

rₒ sin(θₒ−θ)=e cos θ [Equation 1]

e sin θ+r=rₒ cos(θₒ−θ) [Equation 2]

From Equation 1, θ0 may be represented as in the following Equation 3.

$${θ}_{o} = θ + {sin}^{- 1} \frac{e cos θ}{{r}_{o}} \qquad [ Equation 3 ]$$

When substituting Equation 3 in Equation 2, r represented as the following Equation 4 may be obtained.

$$r = {r}_{o} cos ( {sin}^{- 1} \frac{e cos θ}{{r}_{o}} ) - e sin θ \qquad [ Equation 4 ]$$

In Equation 4, r denotes an amount of change in a radius having entire run-out, rc denotes a radius of a rotor (photosensitive drum), rA denotes a magnitude of run-out variation, θA denotes a run-out variation phase, and e denotes eccentricity.

When r0 of a general rotor has sinusoidal run-out represented as r0=rc+rA sin(θ+θA), Equation 4 may be represented as the following Equation 5.

$$r = ( {r}_{c} + {r}_{A} sin ( θ + {θ}_{A} ) ) cos ( {sin}^{- 1} \frac{e cos θ}{{r}_{c} + {r}_{A} sin ( θ + {θ}_{A} )} ) - esinθ \qquad [ Equation 5 ]$$

In Equation 5, rc denotes a radius of a rotor (photosensitive drum), rA denotes a magnitude of run-out variation, and θA denotes a run-out variation phase.

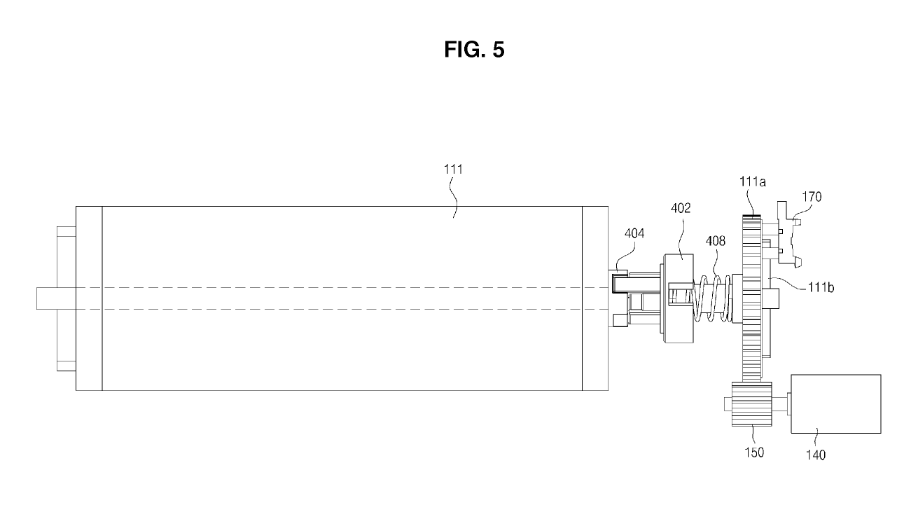

Thus, when accuracy of a component used for fixing the photosensitive drum 111 is not sufficiently managed, run-out characteristics of each of the photosensitive drums 111 may be highly likely to have mutually different phases and sizes as found by Equation 5. According to an exemplary embodiment, couplers (see, for example, 402 and 404 of FIGS. 4 and 5) having an improved structure for mechanically fastening the photosensitive drum 111 to the plurality of driving gears (see 111a_{—}k, 111a_{—}c, 111a_{—}m, and 11a_{—}y of FIG. 4) for transmitting a driving force (rotatory power) of the motor 140 to the photosensitive drum 111 may be used. Therefore, when the plurality of photosensitive drums 111 are fastened to the plurality of driving gears, a phase of each of the plurality of photosensitive drums 111 may be synchronized with a phase of each of the plurality of driving gears that may be set in advance.

FIG. 3B illustrates an exemplary entire run-out profile (AC component) when a run-out variation phase θA is 0, 90, 180, and 270 degrees, respectively.

FIG. 4 is an exploded perspective view illustrating a connection relationship between a photosensitive drum and a motor of an image forming apparatus in accordance with an embodiment, and FIG. 5 is a side view illustrating an exemplary connection relationship between a photosensitive drum and a motor of an image forming apparatus illustrated, for example, in FIG. 4.

As illustrated in FIGS. 4 and 5, the plurality of driving gears 111a that are provided so as to correspond to each of the four photosensitive drums 111 disposed in parallel with each other in a tandem method may be rotatably fixed and installed inside the image forming apparatus. The groove position detecting protrusion 111b is formed on one side surface of the driving gear (for example, 111a_{—}k) that is a reference among the four driving gears 111a as illustrated in FIG. 2, and the groove position sensing unit 170 may be fixed and installed above the groove position detecting protrusion 111b while being spaced apart from the driving gear 111a. When the driving gear 111a is rotated, the groove position detecting protrusion 111b of the driving gear 111a passes the groove position sensing unit 170 in a fixed state, and therefore the groove position sensing unit 170 may detect both ends (groove position) of the groove position detecting protrusion 111b. The groove position detecting protrusion 111b may be provided even in the remaining driving gears 111a_{—}c, 111a_{—}m, and 111a_{—}y except the driving gear 111a_{—}k that is a reference. In an image forming apparatus in accordance with an embodiment, the groove position detection through the groove position sensing unit 170 may be performed only with respect to a single driving gear 111a that is a reference. This is because the image forming apparatus in accordance with an embodiment simultaneously drives the plurality of driving gears 111a and the plurality of photosensitive drums 111 using the single motor 140. Thus, the groove position detecting protrusion 111b may not be formed in each of the driving gears 111a, and the groove position sensing unit 170 may not be formed in each of the driving gears 111a.

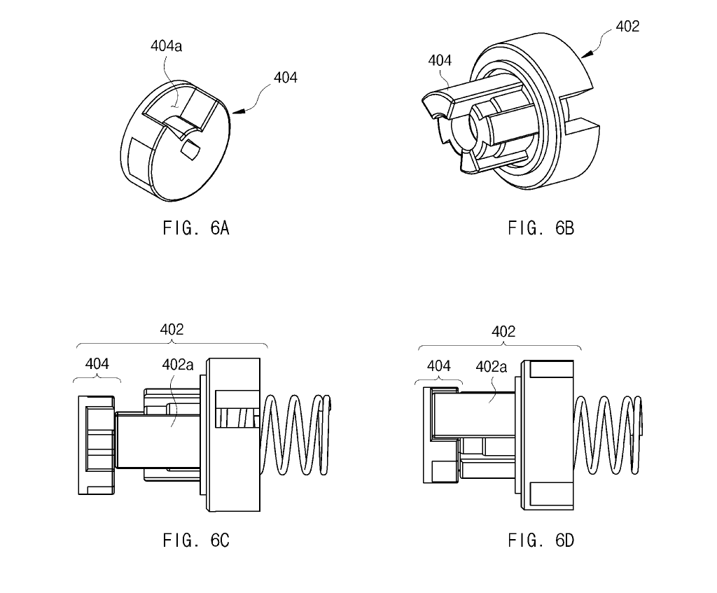

On another surface of each of the driving gear 111a, a driving gear rotating shaft 406 of the driving gear 111a may be provided while being extended in a fixed length in a normal direction of the other surface of the driving gear 111a. A driving gear side coupler (driving side coupler) 402 may be fastened to the driving gear rotating shaft 406. An insertion port 410 in which the driving gear rotating shaft 406 is inserted and fixed may be formed in a center portion of the driving gear side coupler 402, and an elastic body 408 (for example, spring) is provided at an inlet side of the insertion port 410. An inner diameter of the insertion port 410 of the driving gear side coupler 402 coincides with an outer diameter of the driving gear rotating shaft 406 of the driving gear 111a, and the driving gear side coupler 402 may be mechanically fastened to the driving gear 111a so as to be rotated together with the driving gear 111a in a state in which the driving gear side coupler 402 is inserted into the insertion port 410 of the driving gear 111a. For example, the insertion port 410 and the driving gear rotating shaft 406 have different concavo-convex structures and the concavo-convex structures are coupled to each other, and therefore the driving gear side coupler 402 is rotated together with the driving gear 111a without running idle, when the driving gear 111a is rotated. An inner diameter of the elastic body 408 may be larger than or equal to an outer diameter of the driving gear rotating shaft 406. Thus, the driving gear rotating shaft 406 may pass through the inner diameter of the elastic body 408, and may be inserted into the insertion port 410 of the driving gear side coupler 402. When the driving gear side coupler 402 is fastened to the driving gear 111a, a length of the elastic body 408 may be set so that only a part of the elastic body 408 is compressed rather than a 100% compressed state. That is, when the driving gear side coupler 402 is fastened to the driving gear 111a, it is preferable that the elastic body 408 be additionally compressed by an external force applied to the driving gear side coupler 402, whereby elasticity is created. This is to enable a photosensitive drum side coupler (driven side coupler) 404 provided in the photosensitive drum 111 and the driving gear side coupler 402 to be softly and completely fastened to each other when the photosensitive drum 111 is coupled to the driving gear 111a. Exemplary shapes and structures of the photosensitive drum side coupler 404 and the driving gear side coupler 402 are described with reference, for example, to FIGS. 6A-6D.

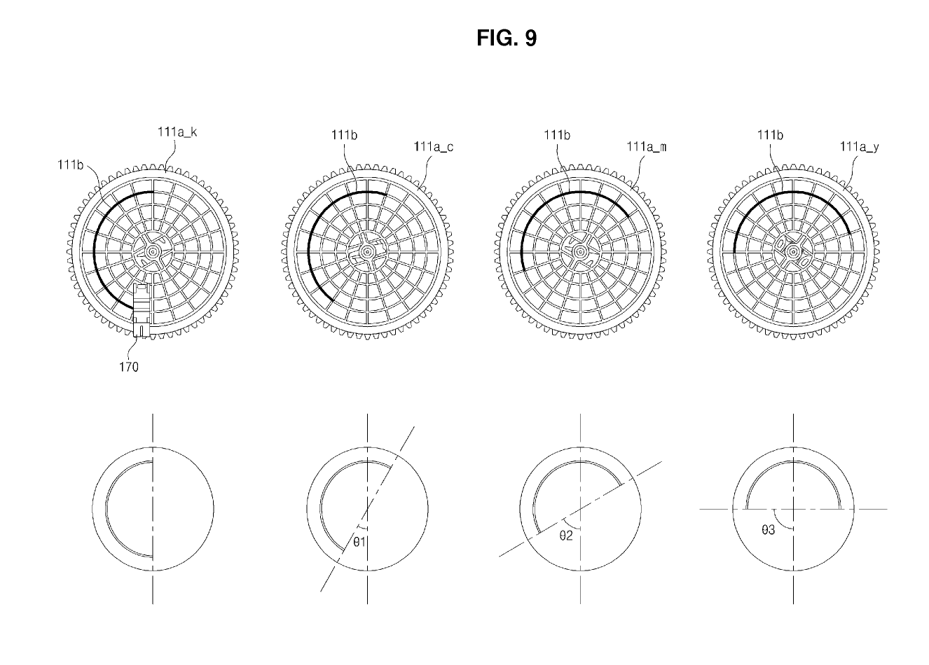

As illustrated in FIGS. 4, 5A, and 5B, the driving gear 111a and the photosensitive drum 111 may be mechanically coupled to each other through the driving gear side coupler 402 and the photosensitive drum side coupler 404, and therefore rotatory power of the driving gear 111a may be transmitted to the photosensitive drum 111. In an embodiment, the driving gear side coupler 402 and the photosensitive drum side coupler 404 are devices that enable a relative position on a rotation plane of the photosensitive drum 111 with respect to the driving gear 111a to maintain a constant relationship. For example, in a case in which the driving gear 111a is positioned in a groove position, when an angle on the rotation plane of the photosensitive drum 111 is 0, the driving gear side coupler 402 and the photosensitive drum side coupler 404 may act in such a manner that angles on the rotation planes of the plurality of photosensitive drums 111 all have displacement of 45 degrees when the driving gear 111a is rotated clockwise by 45 degrees in the groove position. When all of the four photosensitive drums 111 are coupled to the corresponding driving gears 111a through the driving gear side coupler 402 and the photosensitive drum side coupler 404 and all of the four driving gears 111a are simultaneously driven by the single motor 140, the four photosensitive drums 111 may be all synchronized with an initially set phase to be rotated. By such a structure of the driving gear side coupler 402 and the photosensitive drum side coupler 404, when at least one of the plurality of photosensitive drums 111 is coupled to at least one of the plurality of driving gears 111a, the driving gear side coupler 402 and the photosensitive drum side coupler 404 are coupled to each other in an one-directional coupling method, and therefore the plurality of photosensitive drums 111 follow a predetermined phase of the plurality of driving gears 111a. A one-directional coupling method may indicate that even when the driving gear side coupler 402 and the photosensitive drum side coupler 404 are attempted to be coupled to each other at any angle on the rotation plane, actual coupling is performed only at a predetermined single angle. Exemplary actions of the photosensitive drum side coupler 404 and the driving gear side coupler 402 associated are disclosed, for example, with reference to FIG. 9.

As illustrated in FIG. 5, the motor 140 that provides a driving force for rotating the photosensitive drum 111 may be mechanically connected to the driving gear 111a through a gear member 150. The photosensitive drum 111 may be rotated by receiving the driving force (rotatory power) of the motor 140 through the action of the gear member 150.

FIGS. 6A to 6D illustrate an embodiment of a coupler that connects a driving gear and a photosensitive drum of an image forming apparatus in accordance with one embodiment.

FIG. 6A illustrates the photosensitive drum side coupler 404, FIG. 6B illustrates the driving gear side coupler 402, FIG. 6C illustrates a state in which the driving gear side coupler 402 and the photosensitive drum side coupler 404 are not coupled to each other, and FIG. 6D illustrates a state in which the driving gear side coupler 402 and the photosensitive drum side coupler 404 are coupled to each other.

As illustrated in FIG. 6A, a single fastening groove 404a having directivity may be formed in a part of one side surface (a surface facing the driving gear side coupler 402 at the time of coupling) of the photosensitive drum side coupler 404. The directivity of the fastening groove 404a may indicate that the photosensitive drum side coupler 404 and the driving gear side coupler 402 are fastened to each other only in a state of mutually facing one specific direction when the driving gear side coupler 402 is coupled to the photosensitive drum side coupler 404. The fastening groove 404a of FIG. 6A may be formed into an asymmetric fan shape in order to have directivity, but the present invention is not limited only thereto. That is, the fastening groove 404a may be formed into other various shapes as long as it has directivity. A single protrusion 402a is formed in the driving gear side coupler 402 illustrated in FIG. 6B. When the driving gear side coupler 402 and the photosensitive drum side coupler 404 are coupled to each other, the protrusion 402a of the driving gear side coupler 402 is inserted into the fastening groove 404a of the photosensitive drum side coupler 404 illustrated in FIG. 6A. Thus, a cross-section of the protrusion 402a of the driving gear side coupler 402 may be smaller than or equal to a cross-section of the fastening groove 404a of the photosensitive drum side coupler 404. According to an embodiment, the cross-section of the protrusion 402a of the driving gear side coupler 402 and the cross-section of the fastening groove 404a of the photosensitive drum side coupler 404 have the same size and shape in order to enable a stable fastening state to be maintained by preventing a gap from being created when the driving gear side coupler 402 and the photosensitive drum side coupler 404 are coupled to each other.

According to an embodiment, when the protrusion 402a of the driving gear side coupler 402 is not accurately fastened to the fastening groove 404a of the photosensitive drum side coupler 404, the driving gear side coupler 402 and the photosensitive drum side coupler 404 are not coupled to each other as illustrated in FIG. 6C. As illustrated in FIG. 6D, only when the protrusion 402a of the driving gear side coupler 402 is accurately fastened to the fastening groove 404a of the photosensitive drum side coupler 404, the driving gear side coupler 402 and the photosensitive drum side coupler 404 are coupled to each other. This indicates that any one of the driving gear side coupler 402 and the photosensitive drum side coupler 404 is dependent on the other one thereof. In order to couple the photosensitive drum side coupler 404 to the driving gear side coupler 402 in a state in which the driving gear side coupler 402 is fixed, a position of the fastening groove 404a of the photosensitive drum side coupler 404 may be adjusted so as to correspond to a position of the protrusion 402a of the driving gear side coupler 402. To couple the photosensitive drum side coupler 404 to the driving gear side coupler 402 in a state in which the driving gear side coupler 402 is rotated clockwise at an angle of 45 degrees to be fixed, the position of the fastening groove 404a of the photosensitive drum side coupler 404 may be rotated clockwise at an angle of 45 degrees so as to correspond to the position of the protrusion 402a of the driving gear side coupler 402. Thus, the driving gear side coupler 402 and the photosensitive drum side coupler 404, the driving gear side coupler 402 and the photosensitive drum side coupler 404 are coupled to each other in the one-directional coupling method when at least one of the plurality of photosensitive drums 111 is coupled to at least one of the plurality of driving gears 111a. Therefore, the plurality of photosensitive drums 111 follow a predetermined phase of the plurality of driving gears 111a. The one-directional coupling method indicates that even when the driving gear side coupler 402 and the photosensitive drum side coupler 404 are attempted to be coupled to each other at any angle on the rotation plane, actual coupling is performed only at a predetermined single angle.

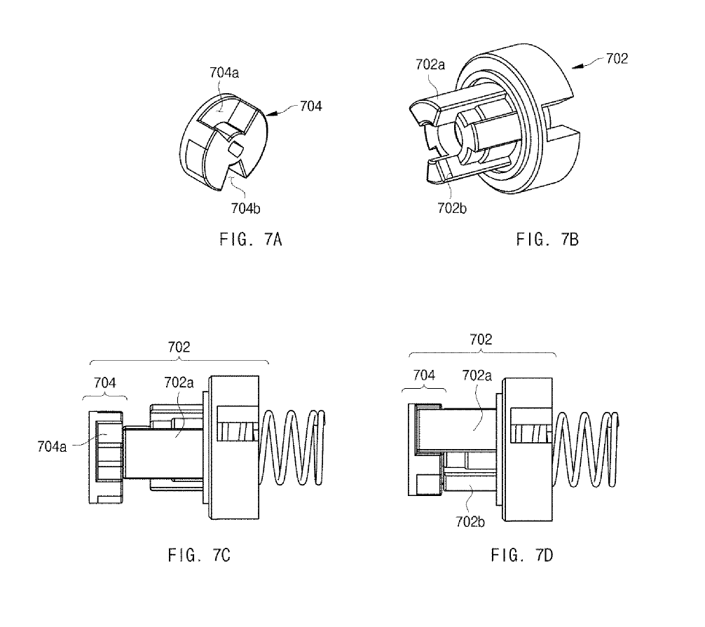

FIGS. 7A to 7D illustrate an embodiment of a coupler that connects a driving gear and a photosensitive drum of an image forming apparatus in accordance with an embodiment. FIG. 7A illustrates a photosensitive drum side coupler 704, FIG. 7B illustrates a driving gear side coupler 702, FIG. 7C illustrates a state in which the driving gear side coupler 702 and the photosensitive drum side coupler 704 are not coupled to each other, and FIG. 7D illustrates a state in which the driving gear side coupler 702 and the photosensitive drum side coupler 704 are coupled to each other.

As illustrated in FIG. 7A, two fastening grooves 704a and 704b having directivity are formed in a part of one side surface (a surface facing the driving gear side coupler 702 at the time of coupling) of the photosensitive drum side coupler 704. Both the fastening groove 704a and 704b of FIG. 7A are formed into a fan shape, but may be formed in various shapes while not limited only thereto. The two fastening grooves 704a and 704b may have mutually different sizes or shapes to enable directivity of any one of the driving gear side coupler 702 and the photosensitive drum side coupler 704 to be dependent on the other one thereof when the driving gear side coupler 702 and the photosensitive drum side coupler 704 are coupled to each other. The directivity indicates that the photosensitive drum side coupler 704 and the driving gear side coupler 702 are fastened to each other only in a state of mutually facing one specific direction when the driving gear side coupler 702 is coupled to the photosensitive drum side coupler 704. Two protrusions 702a and 702b may be formed in the driving gear side coupler 702 illustrated in FIG. 7B. When the driving gear side coupler 702 and the photosensitive drum side coupler 704 are coupled to each other, the protrusions 702a and 702b of the driving gear side coupler 702 are inserted into the fastening grooves 704a and 704b of the photosensitive drum side coupler 704 illustrated in FIG. 7A. Thus, a cross-section of each of the protrusions 702a and 702b of the driving gear side coupler 702 should be smaller than or equal to a cross-section of each of the fastening grooves 704a and 704b of the photosensitive drum side coupler 704. The cross-section of each of the protrusions 702a and 702b of the driving gear side coupler 702 and the cross-section of each of the fastening grooves 704a and 704b of the photosensitive drum side coupler 704 may have the same size and shape in order to enable a stable fastening state to be maintained by preventing a gap from being created when the driving gear side coupler 702 and the photosensitive drum side coupler 704 are coupled to each other. In a geometric relationship between the fastening grooves 704a and 704b and the protrusions 702a and 702b, only in a case of a structure in which the protrusion 702b is not fastened to the fastening groove 704a and the protrusion 702a is not fastened to the fastening groove 704b in the opposite structure in which the protrusion 702a is fastened to the fastening groove 704a and the protrusion 702b is fastened to the fastening groove 704b, directivity of any one of the driving gear side coupler 702 and the photosensitive drum side coupler 704 is dependent on the other one thereof.

When the protrusions 702a and 702b of the driving gear side coupler 702 are not accurately fastened to the fastening grooves 704a and 704b of the photosensitive drum side coupler 704, the driving gear side coupler 702 and the photosensitive drum side coupler 704 are not coupled to each other as illustrated in FIG. 7C. As illustrated in FIG. 7D, only when the protrusions 702a and 702b of the driving gear side coupler 702 are accurately fastened to the fastening grooves 704a and 704b of the photosensitive drum side coupler 704, the driving gear side coupler 702 and the photosensitive drum side coupler 704 are coupled to each other. This indicates that any one of the driving gear side coupler 702 and the photosensitive drum side coupler 704 is dependent on the other one thereof. To couple the photosensitive drum side coupler 704 to the driving gear side coupler 702 in a state in which the driving gear side coupler 702 is fixed, a position of each of the fastening grooves 704a and 704b of the photosensitive drum side coupler 704 may be adjusted so as to correspond to a position of each of the protrusions 702a and 702b of the driving gear side coupler 702. To couple the photosensitive drum side coupler 704 to the driving gear side coupler 702 in a state in which the driving gear side coupler 702 is rotated clockwise at an angle of 45 degrees to be fixed, the position of each of the fastening grooves 704a and 704b of the photosensitive drum side coupler 704 may be also rotated clockwise at an angle of 45 degrees so as to correspond to the position of each of the protrusions 702a and 702b of the driving gear side coupler 702. Consequently, in order to couple the driving gear side coupler 702 and the photosensitive drum side coupler 704 to each other, any one of the driving gear side coupler 702 and the photosensitive drum side coupler 704 is dependent on the other one thereof. By such a structure of the driving gear side coupler 702 and the photosensitive drum side coupler 704, the driving gear side coupler 702 and the photosensitive drum side coupler 704 are coupled to each other in the one-directional coupling method when at least one of the plurality of photosensitive drums 111 according to an embodiment is coupled to at least one of the plurality of driving gears 111a, and therefore the plurality of photosensitive drums 111 follow a predetermined phase of the plurality of driving gears 111a. The one-directional coupling method provides that even when the driving gear side coupler 702 and the photosensitive drum side coupler 704 are attempted to be coupled to each other at any angle on the rotation plane, actual coupling is performed only at a predetermined single angle.

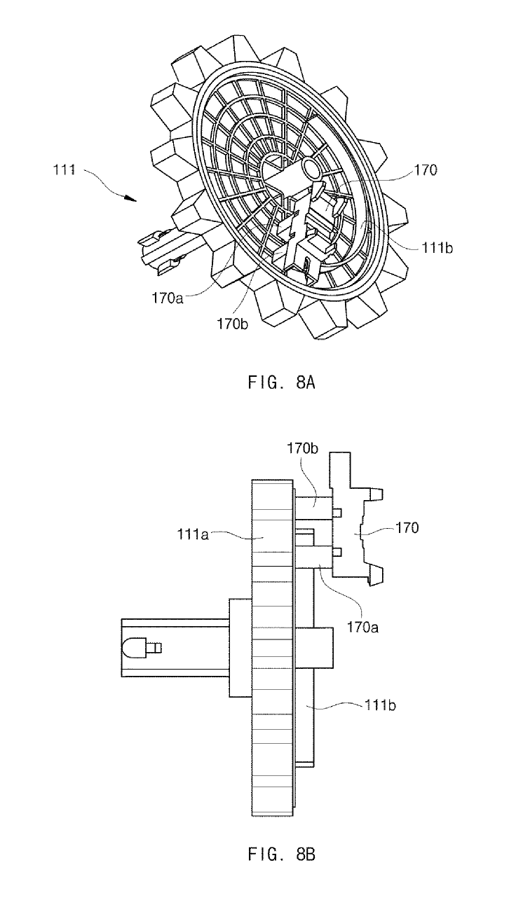

FIGS. 8A and 8B illustrate a groove position detecting protrusion and a groove position sensing unit that are provided in a driving gear of an image forming apparatus in accordance with one embodiment. FIG. 8A is a perspective view illustrating the driving gear 111a and the groove position sensing unit 170, and FIG. 8B is a side view showing the driving gear 111a and the groove position sensing unit 170. As illustrated in FIG. 8A, the groove position sensing unit 170 includes a light emitting unit 170a and a light receiving unit 170b. A groove position detecting protrusion 111b passes between the light emitting unit 170a and the light receiving unit 170b of the groove position sensing unit 170. There is no signal received to the light receiving unit 170b while the groove position detecting protrusion 111b passes between the light emitting unit 170a and the light receiving unit 170b of the groove position sensing unit 170, but when the groove position detecting protrusion 111b is deviated from between the light emitting unit 170a and the light receiving unit 170b of the groove position sensing unit 170, light radiated from the light emitting unit 170a is received to the light receiving unit 170b, and therefore it is possible to detect that at least one end of both ends of the groove position detecting protrusion 111b is deviated from or enters between the light emitting unit 170a and the light receiving unit 170b of the groove position sensing unit 170. The groove position detecting protrusion 111b may be formed on a surface of the driving gear 111a so as to have a semicircular arc shape, and disposed on a concentric circle from a virtual rotating shaft at a center of the driving gear 111a. A length of the groove position detecting protrusion 111b may be changed. When rotation of the driving gear 111a is sufficiently performed, at least one end of both ends of the groove position detecting protrusion 111b is deviated from or enters between the light emitting unit 170a and the light receiving unit 170b of the groove position sensing unit 170. By detecting that the at least one end of both ends of the groove position detecting protrusion 111b is deviated from or enters between the light emitting unit 170a and the light receiving unit 170b of the groove position sensing unit 170, a groove position (that is, kind of reference position) of the driving gear 111a may be detected.

FIG. 9 illustrates phase synchronization of a driving gear of an image forming apparatus in accordance with an embodiment. As illustrated in FIG. 9, in order to drive four photosensitive drums 111 for representing C, M, Y, and K colors, four driving gears 111a are rotatably installed. As illustrated in FIG. 2, the four driving gears 111a are rotated by receiving power from the single motor 140. When each of the driving gears 111a is independently controlled by connecting a motor to each of the driving gears 111a, an increase in a product price, an increase in a product size, a maintenance problem, or the like due to use of the multiple motors may occur. Thus, when driving the four driving gears 111a using the single motor 140, a product price and a product size may be reduced, and the maintenance may be facilitated.

However, it should be noted that, in a case of rotating a large number of rotors (for examples, photosensitive drums or the like) using a single motor, a color registration error may occur when eccentricity and run-out characteristics of each rotor (photosensitive drum) are not sufficiently controlled. The color registration error in the image forming apparatus may cause degradation of print quality, and therefore the color registration error should be minimized in order to obtain more improved print quality. Thus, in the image forming apparatus in accordance with an embodiment, a large number of photosensitive drums are simultaneously driven using only the single motor 140, and phases of components for fixing the photosensitive drums 111 are synchronized, thereby predicting and controlling drive of the large number of photosensitive drums 111 whose phases are synchronized.

In an image forming apparatus in accordance with an embodiment, a phase difference existing between the four driving gears 111a in a state in which the groove positions of the four driving gears 111a coincide with each other as illustrated in FIG. 9 may be detected, and phases of the remaining driving gears 111a_{—}c, 111a_{—}m, and 111a_{—}y except the driving gear 111a_{—}k may be adjusted by θ1, θ2, and θ3, respectively, so that the phase difference becomes 0. Therefore, the four driving gears 111a are in a state in which the phase difference is adjusted through synchronization. As illustrated in FIGS. 6A-6D and 7A-7D, when the driving gear side coupler 402 and the photosensitive drum side coupler 404 are coupled to each other, any one of the driving gear side coupler 402 and the photosensitive drum side coupler 404 is dependent on the other one thereof. Thus, when the driving gear 111a and the photosensitive drum 111 are coupled to each other through the driving gear side coupler 402 and the photosensitive drum side coupler 404, the photosensitive drum 111 is dependent on the phase of the driving gear 111a, and therefore the plurality of photosensitive drums 111 coupled to the plurality of driving gears 111a are synchronized in the same manner as the driving gear 111a, and an operation for image forming may be performed in a state in which the phase difference is removed. That is, according to an embodiment, by the structure of the driving gear side coupler 402 and the photosensitive drum side coupler 404, when at least one of the plurality of photosensitive drums 111 is coupled to at least one of the driving gears 111a, the driving gear side coupler 402 and the photosensitive drum side coupler 404 are coupled to each other in the one-directional coupling method, and therefore the plurality of photosensitive drums 111 follow a predetermined phase of the plurality of driving gears 111a. Thus, the plurality of photosensitive drums 111 coupled to the plurality of driving gears 111a are rotated in accordance with the predetermined (adjusted) phase of the plurality of driving gears 111a, and therefore deviation between the plurality of photosensitive drums 111 that may occur during rotation of the plurality of photosensitive drums 111 may be significantly reduced.

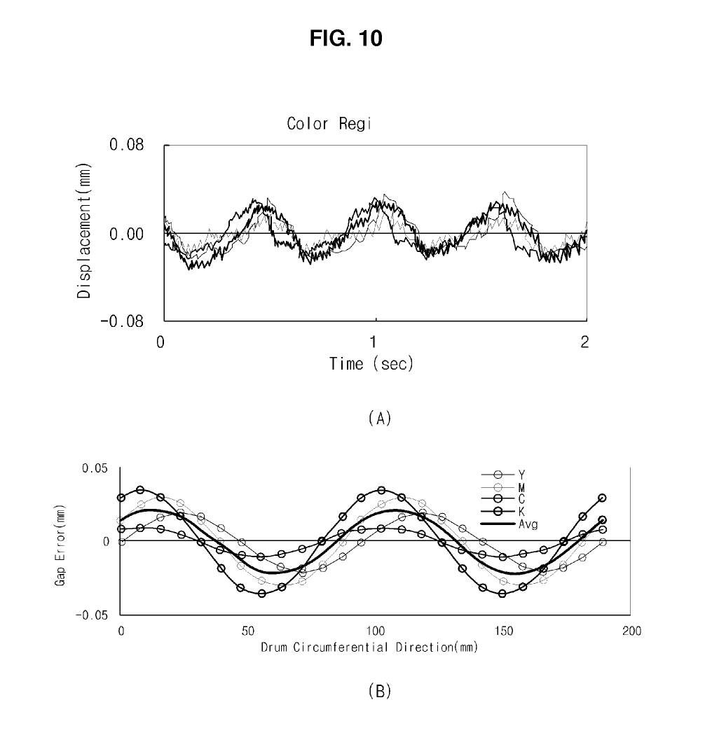

FIGS. 10A-10B illustrate an exemplary detection result of AC components of a photosensitive drum of an image forming apparatus in accordance with an embodiment. As illustrated in FIG. 10A-10B, when a rotor such as the photosensitive drum 111 is driven, run-out characteristics of a component for fixing the rotor appear as an AC component, and a size of the AC component may be in proportion to run-out of the component for fixing the rotor. Thus, when phase information is obtained from the run-out characteristics of the component for fixing the photosensitive drum 111, the AC component that is generated when the photosensitive drum 111 is driven may be predicted, for example, using Equation 5. A phase of the driving gear 111a may be represented in consideration of a pitch between the respective photosensitive drums 111 and a diameter of each of the photosensitive drums 111 when the photosensitive drum 111k is a reference photosensitive drum.
Y: 3θp
M: 2θp
C: 1θp

Here, θp=(πD ? p)÷πD×360° is satisfied, where
p: pitch of photosensitive drum, and
D: diameter of photosensitive drum.

That is, when each of the driving gears 111a is assembled and the photosensitive drum 111 is coupled to the assembled driving gear 111a so that C has a phase difference by 1θp compared to K using K phase as a reference, M has a phase difference by 2θp compared to K, and Y has a phase difference by 3θp compared to K, the phases of each of the four photosensitive drums 111 are synchronized with the phase of each of the four driving gears 111a as illustrated in FIG. 9 using the action of the coupler as an example.

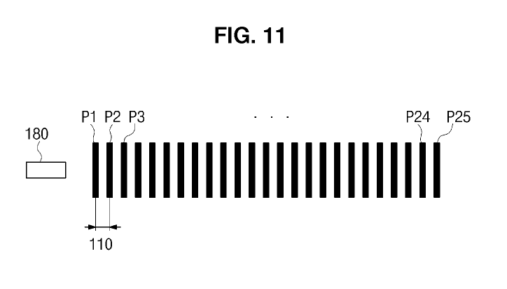

FIG. 11 illustrates a test pattern for performing automatic color registration (ACR) of a photosensitive drum in an image forming apparatus in accordance with an embodiment. As illustrated in FIG. 11, in order to determine a gap variation that occurs by speed variation of the photosensitive drum, the color mis-registration detecting pattern (P) transferred to the intermediate transfer belt 122 includes a large number of rod-shaped patterns (P1, P2, P3, . . . , P24, P25). Each rod-shaped pattern may be designed to have the same thickness and have a gap (110) with the same distance.

The color mis-registration detecting pattern (P) has a length corresponding to an integer multiple of a circumferential length of the photosensitive drum. This may be effective to obtain stable data and increase error fitting accuracy.

The control unit 160 forms black (K), magenta (M), cyan (C), and yellow (Y) patterns with respect to the photosensitive drums 111k, 111m, 111c, and 111y, respectively, and transfers the formed patterns to the intermediate transfer belt 122.

The control unit 160 repeatedly transfers the color mis-registration detecting pattern (P) to the intermediate transfer belt 122 for each of the photosensitive drums 111k, 111m, 111c, and 111y more than once. This is, for example, to detect more accurate data and remove an unexpected measurement value. When transferring each color mis-registration detecting pattern (P) more than once, the control unit 160 forms each color mis-registration detecting pattern (P) in the photosensitive drums 111k, 111m, 111c, and 111y at the same time using a groove position of each of the photosensitive drums 111k, 111m, 111c, and 111y as a reference. The control unit 160 may fit the gap variation due to periodic flux variation of each of the photosensitive drums 111k, 111m, 111c, and 111y with a sine function to determine a gap variation function, and a motor speed function may be obtained using the gap variation function to vary a speed of each of the motors 140k, 140m, 140c, and 140y, and therefore speed variation of the photosensitive drums 111k, 111m, 111c, and 111y may be suppressed, thereby significantly reducing color mis-registration.

The photosensitive drum 111 that is a rotor may have a periodic speed variation. Such a speed variation of the photosensitive drum 111 may cause the gap variation of the color mis-registration detecting pattern transferred to the intermediate transfer belt 122, and such a gap variation is generally represented as a sine curve due to characteristics of the periodic speed variation.

In order to ascertain a relationship between the speed variation of the photosensitive drum 111 and the gap variation of the color mis-registration detecting pattern that occurs due to the speed variation, the gap variation may be represented as follows as a sine function in Equation 6.

gap variation=A sin(ωt+θ) (Equation 6)

In Equation 6, A denotes a variation magnitude, ω denotes an angular velocity (2πf), f denotes a speed variation frequency, and θ denotes a phase.

The gap variation may occur by flux variation of the photosensitive drum 111, and therefore a linear velocity of the photosensitive drum 111 may be represented as follows in Equation 7.

Linear velocity of photosensitive drum=Vo+θA cos(θt+θ) (Equation 7)

In Equation 7, Vo denotes a process speed of the photosensitive drum.

Thus, since the variation magnitude (Av) of the linear velocity of the photosensitive drum is ωA, a position variation magnitude may be obtained as follows in Equation 8.

Position variation magnitude (A)=Av/ω=Av/(2πf) (Equation 8)

A speed of the motor 140 to be controlled may be represented as follows in Equation 9.

Motor speed=VM+ωAVM/Vo sin(ωt+θM) (Equation 9)

In Equation 9, VM denotes a speed of the motor 140 that provides an average speed of the photosensitive drum 111, and θM denotes a speed phase of the motor 140.

From Equation 9, for example, it can be seen that the gap variation is in proportion to a magnitude of the speed variation, and in reverse proportion to the variation frequency. That is, an amount of gap variation may be increased along with an increase in the speed variation of the photosensitive drum 111 or a reduction in the frequency of the speed variation thereof. Thus, in order to improve the gap variation, for example, the speed variation of the photosensitive drum 111 should be alleviated.

Even when the motor 140 provides constant rotatory power, an error mechanism may be created while being subjected to multiple transmission processes, and a defect such as color mis-registration may occur. Conversely, when a relationship between the gap variation of the color mis-registration detecting pattern and the speed of the motor 140 is known, the gap variation may be improved through appropriate motor speed variation control.

Thus, in order to suppress inherent periodic speed variation of a rotor that is a direct cause of the color mis-registration, the gap variation of the color mis-registration detecting pattern that occurs by linear velocity variation of the photosensitive drum 111 may be determined, and a relationship between the gap variation and the motor speed may be determined based on the determined gap variation to thereby alleviate the linear velocity variation of the photosensitive drum 111, thereby reducing the color mis-registration.

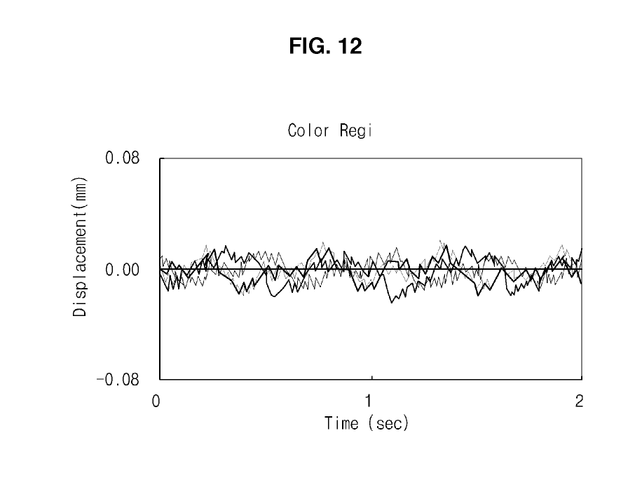

FIG. 12 illustrates results of phase synchronization control and AC average control of an image forming apparatus in accordance with an embodiment. FIG. 10A is a graph illustrating exemplary values before performing AC average control, and FIG. 12 is a graph illustrating exemplary values after performing the AC average control. Through comparison between the graphs of FIGS. 10B and 12, it can be seen that a phase displacement of each of the photosensitive drums 111 is significantly reduced through mechanical phase synchronization between the driving gear 111a and the photosensitive drum 111 of the image forming apparatus in accordance with an embodiment.

The image forming apparatus according an embodiment may mechanically synchronize eccentricity and run-out deviation for each photosensitive drum of an image forming apparatus that does not individually drive the photosensitive drums. Accordingly, a color registration error can be reduced by controlling a linear velocity variation of the photosensitive drum in order to stabilize a deviation of mass production quality of a mechanical approach.

Although a few embodiments have been shown and described, it would be appreciated by those skilled in the art that changes may be made in these embodiments without departing from the principles and spirit of the invention, the scope of that is defined in the claims and their equivalents.

What is claimed is:

1. An image forming apparatus comprising:
a plurality of photosensitive drums;
a single motor;
a plurality of driving gears installed in accordance with a predetermined phase so as to cancel deviation therebetween and simultaneously driven by the single motor;
a plurality of driving side couplers provided in each of the plurality of driving gears and rotated together with the plurality of driving gears; and
a plurality of driven side couplers provided in each of the plurality of photosensitive drums and coupled to the plurality of driving side couplers,
wherein, when at least one of the plurality of photosensitive drums is coupled to at least one of the plurality of driving gears, the driving side coupler and the driven side coupler are coupled to each other in an one-direction coupling method, and therefore the plurality of photosensitive drums follow a predetermined phase of the plurality of driving gears.

2. The image forming apparatus according to claim 1, wherein a single fastening groove having directivity is formed in the plurality of driven side couplers,
a single protrusion having directivity is formed in the plurality of driving side couplers, and
the protrusion of the plurality of driving side couplers is inserted into the fastening groove of the plurality of driven side couplers in accordance with the directivity when the plurality of photosensitive drums are coupled to the plurality of driving gears.

3. The image forming apparatus according to claim 2, wherein the fastening groove of the plurality of driven side couplers is asymmetrically formed so as to have the directivity.

4. The image forming apparatus according to claim 2, wherein an elastic body is provided in each of the plurality of driving side couplers, and when at least one of the plurality of photosensitive drums is coupled to at least one of the plurality of driving gears, the plurality of driving side couplers are pressurized toward the plurality of driven side couplers by the elastic body so that a bonding force between the plurality of driving side couplers and the plurality of driven side couplers is maintained.

5. The image forming apparatus according to claim 1, wherein at least two fastening grooves having mutually different directivity are formed in the plurality of driven side couplers,
at least two protrusions having mutually different directivity are formed in the plurality of driving side couplers, and
when the plurality of photosensitive drums are coupled to the plurality of driving gears, the at least two protrusions of the plurality of driving side couplers are inserted into the fastening groove having corresponding directivity of the plurality of driven side couplers so that the plurality of photosensitive drums and the plurality of driving gears are coupled to each other in the one-direction coupling method.

6. The image forming apparatus according to claim 5, wherein the at least two fastening grooves of the plurality of driven side couplers are formed into mutually different shapes so as to have the directivity.

7. The image forming apparatus according to claim 5, wherein the at least two fastening grooves of the plurality of driven side couplers are formed to have mutually different sizes so as to have the directivity.

8. The image forming apparatus according to claim 5, wherein an elastic body is provided in each of the plurality of driving side couplers, and when at least one of the plurality of photosensitive drums is coupled to at least one of the plurality of driving gears, the plurality of driving side couplers are pressurized toward the plurality of driven side couplers by the elastic body so that a bonding force between the plurality of driving side couplers and the plurality of driven side couplers is maintained.

9. The image forming apparatus according to claim 8, wherein an insertion port in which a rotating shaft of the driving gear is inserted and fixed is formed in a center portion of each of the plurality of driving side couplers, and
the elastic body is installed at an inlet side of the insertion port.

10. The image forming apparatus according to claim 1, wherein a groove position detecting protrusion is formed in at least one of the plurality of driving gears, and
the image forming apparatus further includes a single groove position sensing unit for detecting the groove position detecting protrusion.

11. The image forming apparatus according to claim 10, wherein the groove position detecting protrusion is formed on a surface of at least one of the plurality of driving gears so as to have a semicircular arc shape.

12. The image forming apparatus according to claim 11, wherein the groove position sensing unit includes a light emitting unit and a light receiving unit, and
a groove position of the photosensitive drum is determined through a difference between a light receiving state when the groove position detecting protrusion is positioned between the light emitting unit and the light receiving unit of the groove position sensing unit and a light receiving state when the groove position detecting protrusion is deviated from between the light emitting unit and the light receiving unit.

13. An image forming apparatus comprising:
a plurality of photosensitive drums;
a single motor;
a plurality of driving gears installed in accordance with a predetermined phase so as to cancel deviation therebetween and simultaneously driven by the single motor;
a plurality of driving side couplers provided in each of the plurality of driving gears and rotated together with the plurality of driving gears; and
a plurality of driven side couplers provided in each of the plurality of photosensitive drums and coupled to the plurality of driving side couplers,
wherein a single fastening groove having directivity is formed in the plurality of driven side couplers, a single protrusion having directivity is formed in the plurality of driving side couplers, and when at least one of the plurality of photosensitive drums is coupled to at least one of the plurality of driving gears, the driving side coupler and the driven side coupler are coupled in an one-directional coupling method by the directivity of the single protrusion and the directivity of the single groove, and therefore the plurality of photosensitive drums follow a predetermined phase of the plurality of driving gears.

14. An image forming apparatus comprising:
a plurality of photosensitive drums;
a single motor;
a plurality of driving gears installed in accordance with a predetermined phase so as to cancel deviation therebetween and simultaneously driven by the single motor;
a plurality of driving side couplers provided in each of the plurality of driving gears and rotated together with the plurality of driving gears; and
a plurality of driven side couplers provided in each of the plurality of photosensitive drums and coupled to the plurality of driving side couplers,
wherein at least two fastening grooves having mutually different directivity are formed in the plurality of driven side couplers, at least two protrusions having mutually different directivity are formed in the plurality of driving side couplers, and when at least one of the plurality of photosensitive drums is coupled to at least one of the plurality of driving gears, the driving side coupler is coupled to the driven side coupler in an one-directional coupling method by the directivity of the at least two protrusions and the directivity of the at least two grooves, and therefore the plurality of photosensitive drums follow the predetermined phase of the plurality of driving gears.
